(19) United States
(12) Patent Application Publication
(10) Pub. No.: US 2008/0319870 A1
(43) Pub. Date: Dec. 25, 2008

(54) DISTRIBUTED MEDIA REVIEWING FOR CONFORMANCE TO CRITERIA

(75) Inventors: Nandini Ranjitkumar, Phoenix, AZ (US); Adam Bennett Brotman, Seattle, WA (US)

Correspondence Address: Corbis Corporation;c/o DARBY & DARBY P.C., P.O. BOX 770, Church Street Station, NEW YORK, NY, 10008-0770, US

(73) Assignee: Corbis Corporation, Seattle, WA (US)

(21) Appl. No.: 12/143,638

(22) Filed: Jun. 20, 2008

Related U.S. Application Data
(60) Provisional application No. 60/945,886, filed on Jun. 22, 2007.

(51) Int. Cl. G06Q 30/00; G06F 17/00

(52) U.S. Cl. 705/26; 705/400; 700/90

(57) ABSTRACT

Distributing review of content or other items for conformance with quality requirements or other criteria. Embodiments include distributing media assets over an electronic network to a number of reviewers. Each reviewer uses an interface to review a media asset and corresponding metadata submitted by a content provider. The interface guides the reviewers through a consistent and easily understood review of the assets, such that reviews need not be domain experts. The reviewer enters pass/fail decisions, comments, additional metadata, one or more ratings on aspects of the asset, or other reviewer information regarding the asset. A media review manager receives the reviewer information regarding each asset and determines whether each asset satisfies overall acceptance criteria. Accepted assets are made accessible to other users such as customers for searching, licensing, or other uses.

### CROSS-REFERENCE TO RELATED APPLICATIONS

This application claims the benefit of U.S. Provisional Application Ser. No. 60/945,886 entitled “Distributed Media Reviewing For Conformance To Criteria,” filed on Jun. 22, 2007, the benefit of the earlier filing date of which is hereby claimed under 35 U.S.C. §119 (e) and which is further incorporated herein by reference in its entirety.

### TECHNICAL FIELD

The present invention relates to reviewing content, and more particularly, to guiding non-expert reviewers through reviews of content in a distributed network environment.

### BACKGROUND

Content can generally include, but is not limited to, images, pictures, videos, illustrations, drawings, graphics, symbols, text, and audio recordings. Also, content can be digitized and embodied in an electronic format that can be communicated over a network and/or included in a processor readable media. Typical customers of such content for commercial purposes include advertisers, publishers, media companies, graphic designers, editors, art directors, artists, writers, and the like. Additionally, brokers, licensors, or other sellers of digital content often employ several different methods for determining prices for the use of selected content.

Pricing, categorization, usage, or other factors may depend on a number of characteristics of the content. Some characteristics can be readily obtained, such as dimensional size, file size, data format, or the like. Other characteristics are not readily obtained, or are subjective, such as orientation of the subject matter, a descriptive title of the subject matter, a category to which the subject matter belongs, a quality of the data, an aesthetic appeal, an overall rating, and the like. These characteristics are relatively easy for a human to determine, but not very easy for a machine to determine. Consequently, content may be reviewed before it is accepted or offered for license or for sale.

A large volume of content generally requires many reviewers. However, each reviewer may identify different characteristics of the content, or may apply different subjective standards to the same characteristics of the content. Reviewers may also perform reviews at different times and in different locations. Coordinating and consolidating reviews can be a logistical challenge.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates a system diagram of one embodiment of an environment in which the invention may be practiced;

FIG. 2 shows one embodiment of a mobile device that may be included in a system implementing the invention;

FIG. 3 illustrates one embodiment of a network device that may be included in a system implementing the invention;

FIG. 4 is a simplified diagram of a Web-based media licensing system with review capabilities, in accordance with an embodiment of the subject invention;

FIGS. 5A-5C are exemplary user interfaces of a provider-facing interface for uploading, supplying descriptive information about, and pricing images, in accordance with an embodiment of the subject invention;

FIG. 6 is a simplified flowchart of a method for reviewing images, in accordance with an embodiment of the subject invention;

FIG. 7 is an exemplary user interface that a reviewer is shown when he signs, in accordance with an embodiment of the subject invention;

FIG. 8 is an exemplary user interface that a reviewer uses to determine if an image meets specific acceptance criteria, in accordance with an embodiment of the subject invention;

FIG. 9 is an exemplary user interface that a reviewer uses to review metadata assigned by a submitting content provider, to add additional metadata, and to assign ratings, in accordance with an embodiment of the subject invention;

FIG. 10 is an exemplary user interface that a reviewer uses to edit metadata supplied by the content provider, in accordance with an embodiment of the subject invention;

FIG. 11 is an exemplary user interface that a reviewer uses to review an image along with its metadata and to either publish the image to the system or to indicate that he wants to make further changes, in accordance with an embodiment of the subject invention;

FIG. 12 is an exemplary user interface that a content provider uses to review his portfolio of images that have been submitted to the system, in accordance with an embodiment of the subject invention; and

FIG. 13 is an exemplary user interface that a content provider uses to review images that have been declined by the system, in accordance with an embodiment of the subject invention.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods, or devices. Accordingly, the present invention may take the form of an entirely hardware embodiment, an entirely software embodiment or an embodiment combining software and hardware aspects. The following detailed description is, therefore, not to be taken in a limiting sense.

Embodiments of the present invention concern a Web-based media asset licensing system, which receives media assets from content providers, provides a review process, manages the media assets in an archive, and licenses them to customers. Content providers submit media assets to the system. For purposes of clarity, the term “media assets” refers to media files including digital photographs (commonly referred to as “digital images” or simply “images”), videos, vector art, Flash animations, sound files, and the like. Media assets also include descriptive information or “metadata” that provide information supplemental to the media assets. Metadata may be included within the digital media files or stored separately in a database. Note that metadata generally refers to descriptive information about the media asset such as its known subject, keywords in its content, owner, file format, and other information provided by a content provider or readily determined from the media assets. Metadata helps customers search, browse and select media to license.

Subsequently, reviewers assess the media assets for suitability and review, edit, and add descriptive metadata using processes and systems defined and implemented by a media review manager. The steps described herein are collectively referred to as the “media review process” or “review process.”

Conventional media licensing systems typically provide sophisticated media review processes that are operated by highly trained staff. The staff must be trained to use cataloging systems comparable to those used by library scientists to catalog documents in a library. Such cataloging systems typically require the staff to learn considerable domain specific concepts and terminology and to gain familiarity with one or more hierarchical keyword vocabularies. At the other extreme, recent Web-based media licensing systems that have been designed for non-professional customers often entirely eliminate the review process. The absence of a review process makes it possible to submit media assets with no restrictions; e.g., any media asset submitted to the system is published. In contrast, embodiments of the subject invention provide a step-by-step review process that requires little or no professional background or training. Because the subject invention is Web-based, multiple reviewers can review media assets in parallel, no matter if they work in different geographical locations. And they can work at any time of the day. This makes it possible to efficiently review a large number of media assets, thus achieving a reasonable level of quality for the media assets accepted and published by the system at a reasonable cost.

### Illustrative Operating Environments

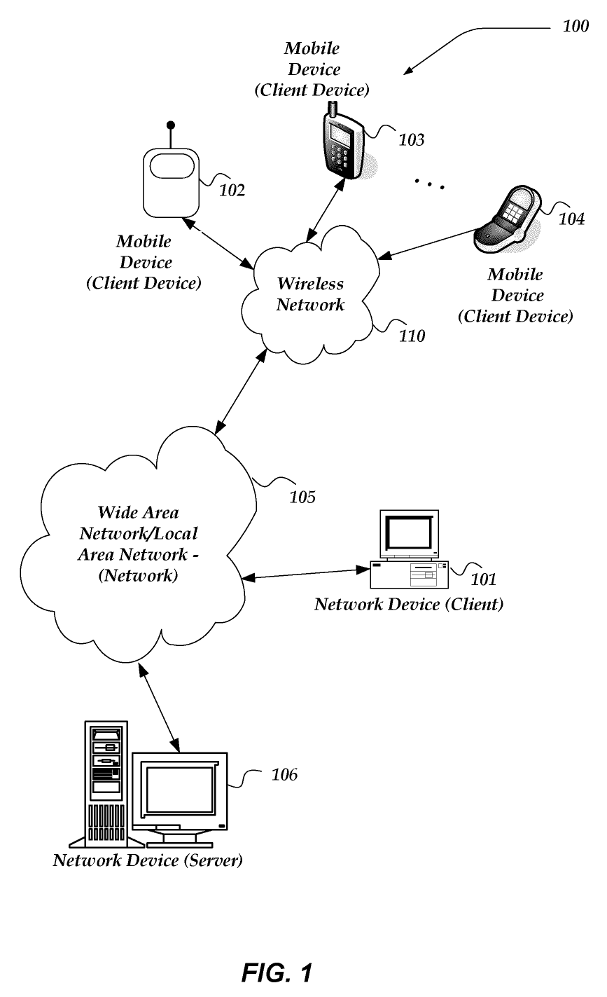

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, server network device 106, mobile devices (clients) 102-104, and client network device 101.

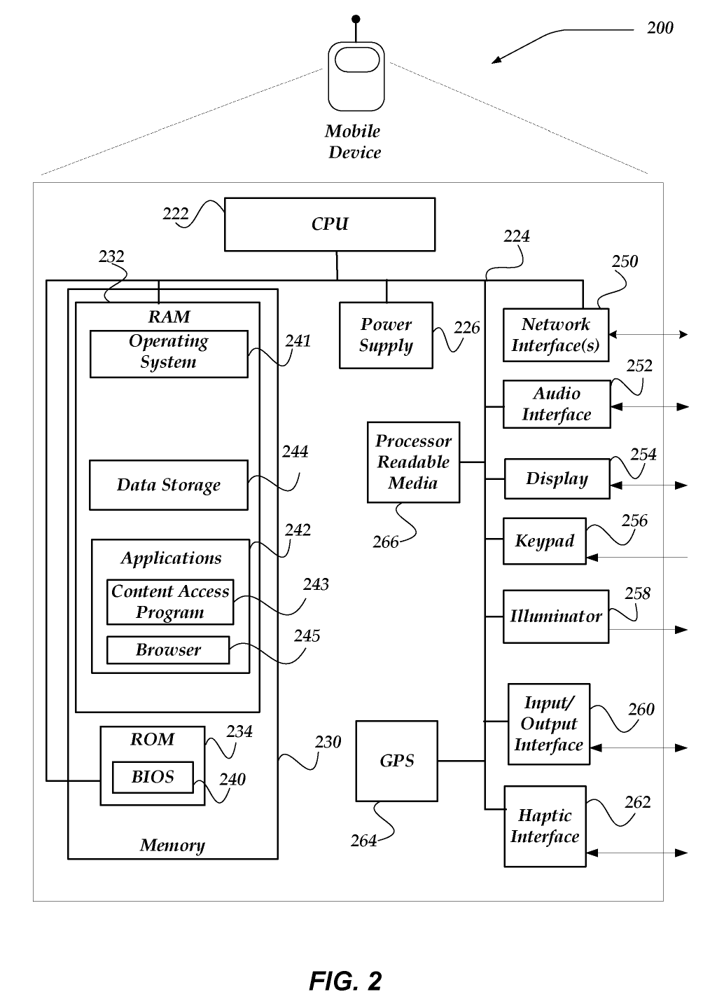

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, media players, video game consoles, multi-media computing platforms, integrated devices combining one or more of the preceding devices, and the like. As such, mobile devices 102-104 typically range widely in terms of capabilities and features. For example, a mobile telephone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol (WAP) message, and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one other client application that is configured to receive content from another computing device. The client application may include a capability to provide and receive textual content, photographic content, graphical content, audio content, and the like. This client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier. The information may also indicate a content format that the mobile device is enabled to process. Such information may be provided in a message, or the like, sent to server network device 106, or other computing devices.

Mobile devices 102-104 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as Network Device 106, client device 101, or the like. However, the present invention is not limited to these message protocols, and virtually any other message protocol may be employed.

Mobile devices 102-104 and client network device 101 may further be configured to include a client application that enables a user to log into a customer account that may be managed by another computing device, such as server network device 106. Such customer account, for example, may be configured to enable the user to search for content, browse web pages, enter a review of the content, select content for purchase, and select uses for the selected content, or the like. However, participation in these activities may also be performed without logging into a customer account.

Client network device 101 may include virtually any computing device capable of communicating over a network to send and receive information, including social networking information, or the like. The set of such devices may include devices that typically connect using a wired or wireless communications medium such as personal computers, multiprocessor systems, microprocessor-based or programmable consumer electronics, network PCs, network appliances, or the like.

Wireless network 110 is configured in part to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, Wifi networks, Wimax networks, cellular telephone networks, and the like. Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple server network device 106 and its components with other computing devices, including, client network device 101, and through wireless network 110 to mobile devices 102-104. Network 105 is enabled to employ any form of processor readable media for communicating information from one networked electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between server network device 106, client device 101, and other computing devices.

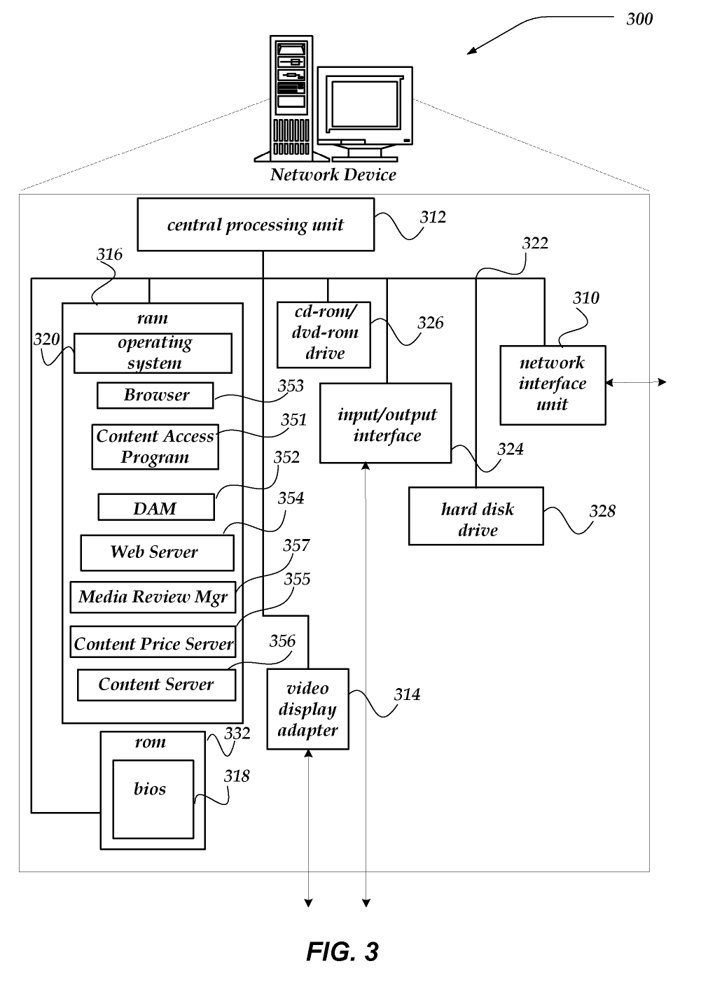

One embodiment of server network Device 106 is described in more detail below in conjunction with FIG. 3. Briefly, however, server network device 106 may include any computing device capable of connecting to network 105. Further, server network device 106 enables one or more server applications to communicate with clients and/or other server applications operating on other computing devices. The server applications can include, but are not limited to, one or more of content server 356, web server 354, content price server 355, media review manager 357, and/or Digital Asset Management server 353. Further, server network device 106 can be arranged to include client applications such as browser 351, content access program 352, and the like.

Furthermore, although FIG. 1 illustrates server network device 106 as a single computing device, the invention is not so limited. For example, one or more functions or applications of server network device 106 may be distributed across one or more other network devices without departing from the spirit and scope of the invention.

### Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264, and processor readable media 266. Processor readable media 266 may include, but is not limited to, hard discs, floppy disks, memory cards, optical discs, and the like. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is arranged for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Data storage 244 may also be employed to store social networking information including vitality information, or the like. At least a portion of the social networking information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may further include browser 245 and content access program 243.

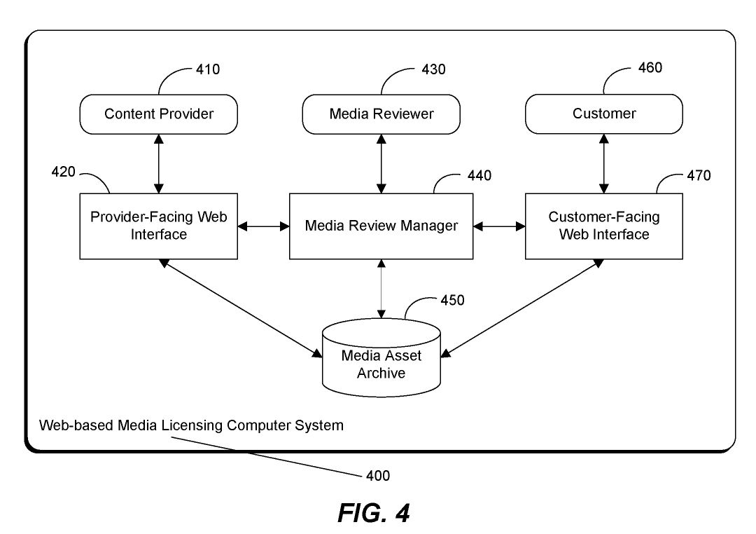

Content access program 243 may be configured either individually or in combination with browser 245 to enable searching and displaying of pages of selected content that is available for license or purchase for one or more uses, which may be selected from predetermined categories. Program 243 can also enable a reviewer to enter selections and other review data regarding content items. Program 243 may communicate the review data to a server for further processing. In one embodiment, content access program 243 enables a user to provide intrinsic value factors and/or extrinsic value factors as part of the review data or apart from the review data. The content may be subsequently priced in part on these factors and made available for license or purchase by customers over a network. Program 243 can also enable a customer to aggregate categories of use. Various embodiments of the processes for content access program 243 are described in more detail below in conjunction with FIGS. 4-11.

### Illustrative Network Device

FIG. 3 shows one embodiment of a network device, according to one embodiment of the invention. Network device 300 may include many more components than those shown. The components shown, however, are sufficient to disclose an illustrative embodiment for practicing the invention. Network device 300 may be arranged to represent, for example, server network device 106 or client network device 101 of FIG. 1.

Network device 300 includes processing unit 312, video display adapter 314, and a mass memory, all in communication with each other via bus 322. The mass memory generally includes RAM 316, ROM 332, and one or more permanent mass storage devices with processor readable media, such as hard disc drive 328, tape drive, optical drive, memory card, and/or floppy disk drive. The mass memory stores operating system 320 for controlling the operation of network device 300. It is envisioned that any general-purpose or mobile operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, or network interface card (NIC).

The mass memory as described above illustrates another type of processor-readable media, namely computer storage media. Computer storage media may include volatile, nonvolatile, removable, and non-removable processor readable media implemented in any method or technology for storage of information, such as processor readable instructions, data structures, program modules, or other data. Examples of computer storage media include RAM, ROM, EEPROM, flash memory or other memory technology, CD-ROM, digital versatile disks (DVD) or other optical storage, memory cards, magnetic cassettes, magnetic tape, magnetic disk storage or other magnetic storage devices, or any other medium which can be used to store the desired information and which can be accessed by a computing device.

The mass memory also stores program code and data. One or more applications 350 can be loaded into mass memory and run on operating system 320. Examples of application programs that may be included are transcoders, schedulers, calendars, database programs, word processing programs, HTTP programs, customizable user interface programs, IPSec applications, encryption programs, security programs, VPN programs, SMS message servers, IM message servers, email servers, account management and the like.

If network device 300 is arranged as a client device, the client applications may include browser 353 and/or content access program 351. However, if network device 300 is arranged to operate and/or as a server, other serving applications may also be included, such as digital asset manager (DAM) 352, Web server 354, Content Price server 355, Content server 356, media review manager 357, and the like. Furthermore, one or more of these serving applications may be arranged on one or more network devices dedicated to providing computing resources.

Content Price server 355 may be arranged to receive and process categories of use, intrinsic value factors, extrinsic value factors, and customized uses, customized pricing information, and the like. Content Price server 355 can preprocess information/data, process information/data in real time, or some combination of both to determine a price for a customer of selected content for one or more predetermined categories of use for the selected content. Also, the determination of the price can be based on one or more extrinsic value factors, intrinsic value factors, and predetermined categories of use. Furthermore, the determination of the price can be relatively static or dynamically updated in response to one or more changes to the information/data employed for determinations by Content Price Server 355. One embodiment for determining the price based on value factors, categories, or the like, is described in U.S. patent application Ser. No. 11/382,204, filed on May 8, 2006 and entitled “Determining Content Pricing For Categories Of Use Based On Extrinsic And Intrinsic Factors,” which is incorporated herein by reference. It is noted, however, that the present invention is not constrained to mechanisms described within such patent application, and other approaches may also be used, without departing from the scope of the invention. In any event, generally, information and/or data can be provided for processing/preprocessing/determinations to Content Price Server 355 by one or more other servers, RSS feeds, APIs, applications, scripts, manual edits, third party sources, content providers, and the like. In addition, in one embodiment, the content provider might be notified about a proposed change in the price.

Content server 356 can be arranged to provide access to content identification information so that the determined prices can be associated with the selected content. Web server 354 may also be arranged to provide the price information for selected content as a service to sources and/or resellers of selected content to customers. DAM 352 may also be arranged to incorporate the price information provided by Content Price server 355.

Media review manager 357 enables content to be submitted by a content provider, reviewed by a reviewer, and licensed by a customer. Media review manager 357 includes a media review manager that manages reviews and review data provided by reviewers. Additionally, network device 300 is arranged to enable one or more of the processes described below in conjunction with FIGS. 4-11.

### Generalized Operation

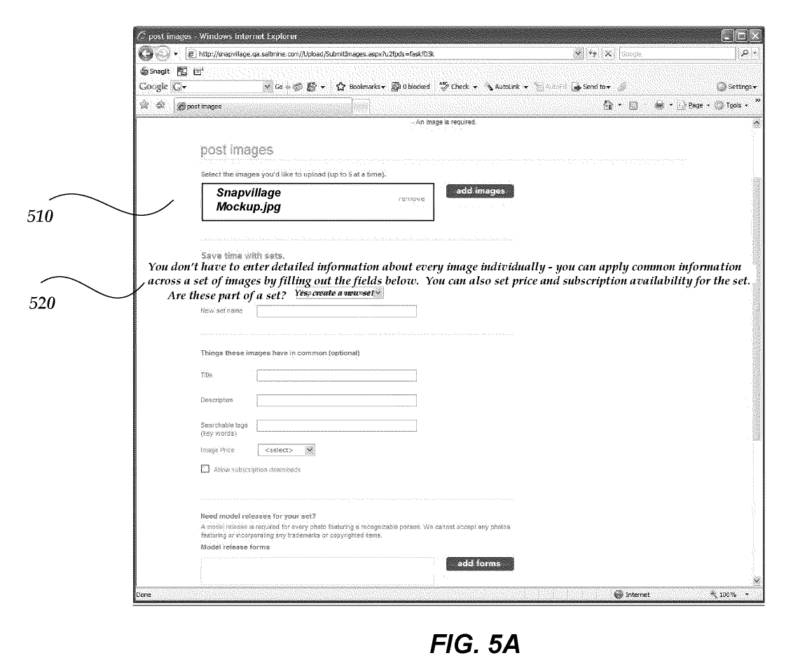

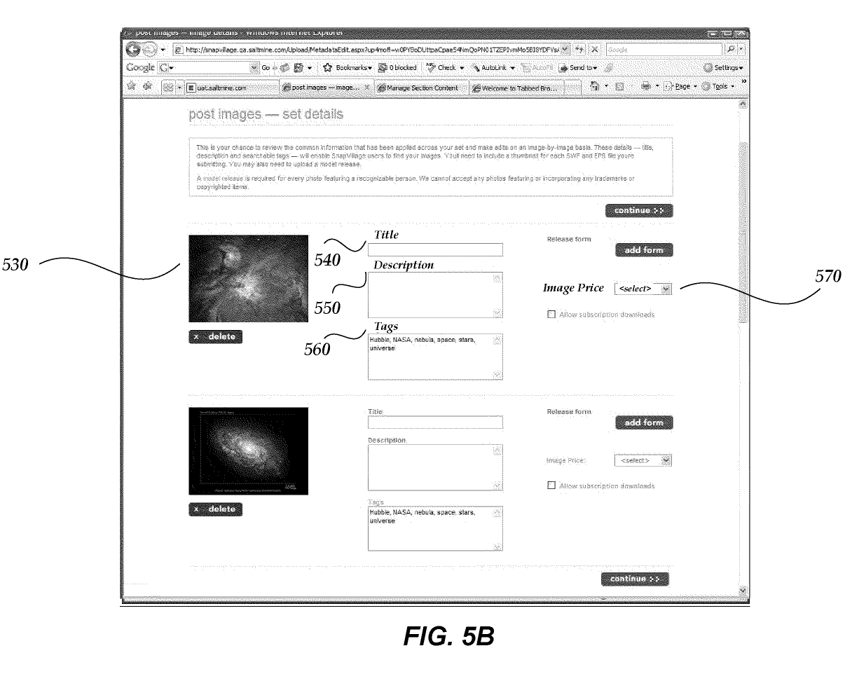

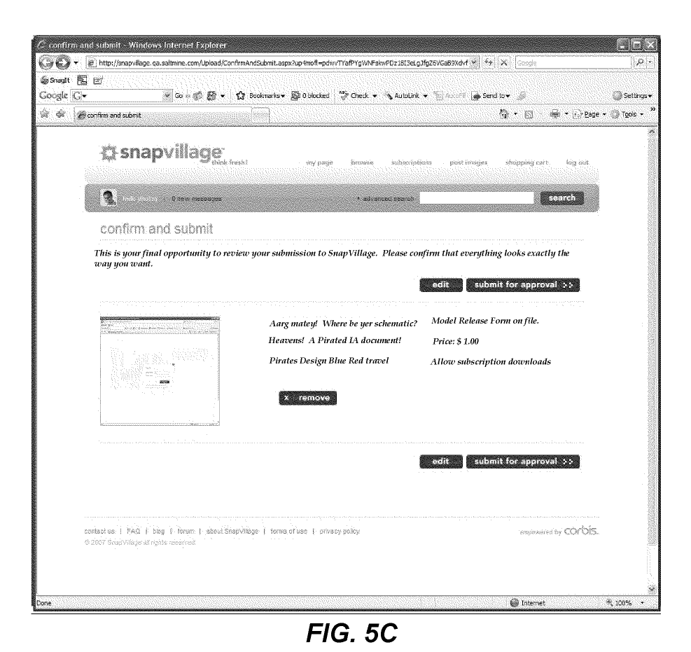

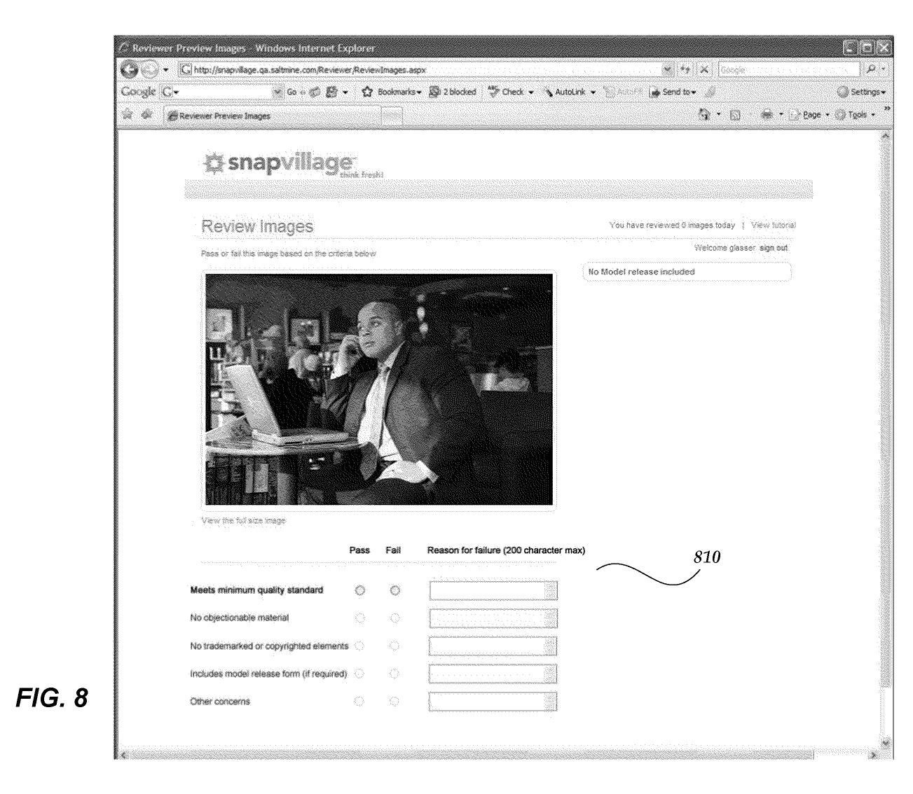

The operation of certain aspects of the invention will now be described with respect to FIGS. 4-15. FIG. 4 provides a general architecture diagram of an embodiment. FIGS. 5-7, and 9-15 illustrate screen shots. FIG. 8 provides an example of particular aspects of a process to further illustrate the invention.

Reference is now made to FIG. 4, which is a simplified diagram of a Web-based media licensing system 400 with review capabilities, in accordance with an embodiment of the subject invention. For purposes of clarity, the media assets referred to in the Figures and in the description below are digital images. Media assets may be any other type of content, such as photographs, videos, graphics, audio, or the like. Embodiments of the invention may also be applied to other items, such as products. Initially, content provider 410 establishes an account using provider-facing Web interface 420. To accomplish this, content provider 410 provides personal information required to establish his account, including for example, his username and password, mailing address and phone number, and notification preferences. This information is stored and maintained by provider-facing Web interface 420.

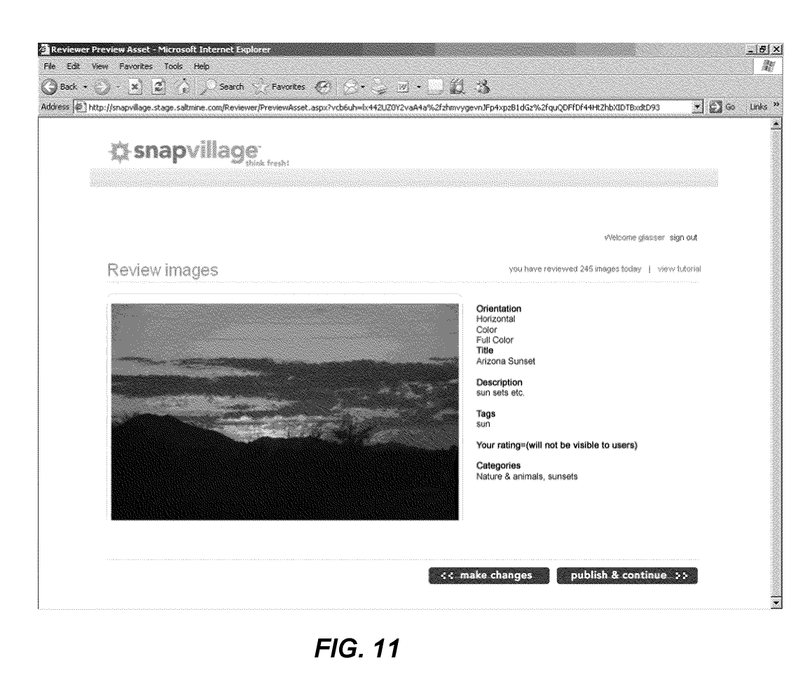

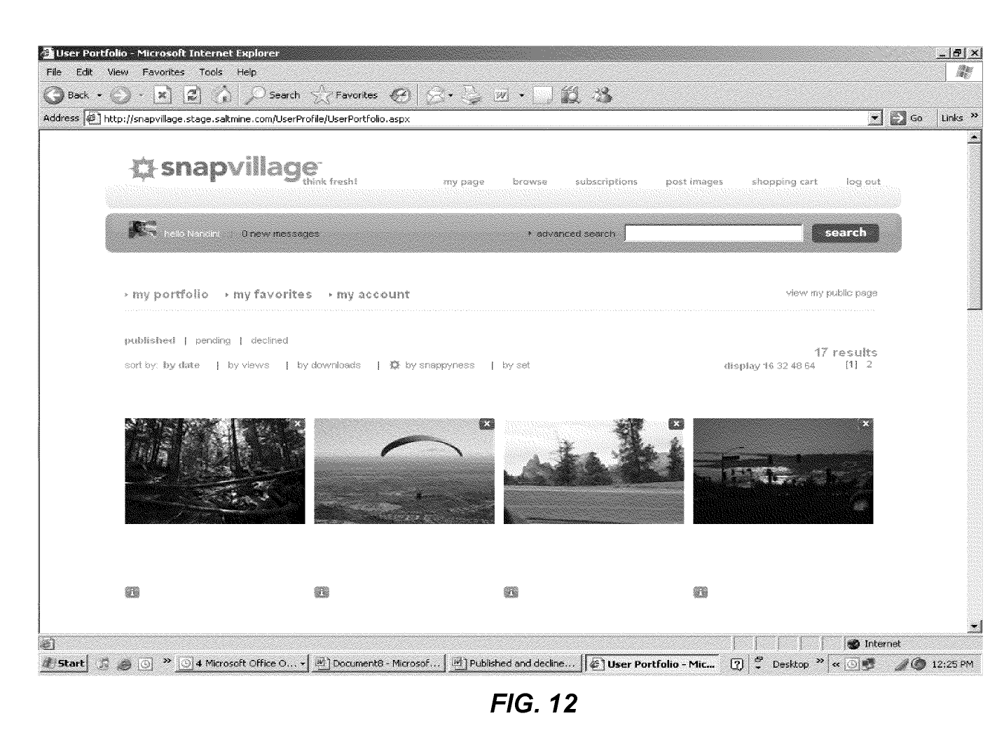

The provider-facing Web interface 420 also provides updated status for each image submitted by content provider 410, as described in detail herein below with respect to FIGS. 11 and 12.

Once an account has been successfully established, content provider 410 uses provider-facing Web interface 420 for uploading his images to system 400, for providing descriptive information, and for providing suggesting prices, as described herein below with respect to FIGS. 5A-5C. Images are stored in media asset archive 450.

System 400 also includes an automated media review manager 440, which is used by media reviewers 430 for assessing the quality of submitted images, for editing and supplying descriptive information, and for rating images, in accordance with an embodiment of the subject invention. Once a media reviewer completes his review, the images deemed acceptable are published for access by content customers.

Customer-facing Web interface 470 allows customers 460 to browse and search for published images, to mark images for future reference, to send images, or links thereto, to colleagues, and to purchase licenses to images.

Reference is now made to FIGS. 5A-5C, which illustrate screen shots of example user interfaces of a provider-facing Web interface, such as provider-facing Web interface 420 of FIG. 4, for uploading images, supplying descriptive information, and pricing images, in accordance with an embodiment of the present invention. Shown in FIG. 5A is an interface that includes an upload control 510 that allows a content provider to upload 1-5 images to system 400. One or more sets controls 520 enables a content provider to organize the images them into sets. As shown in FIG. 5B, after the content provider has uploaded his images, such as images 530, a data entry form enables the content provider to supply or set some information, or “metadata” for each image, including a title 540, a description 550, and one or more tags 560. The content provider can also enter or select an image price 570. For example, the explanation may suggest price ranges based on image quality, size, content, or other intrinsic characteristics. After setting the image details, the content provider may submit his images for approval, as shown in FIG. 5C.

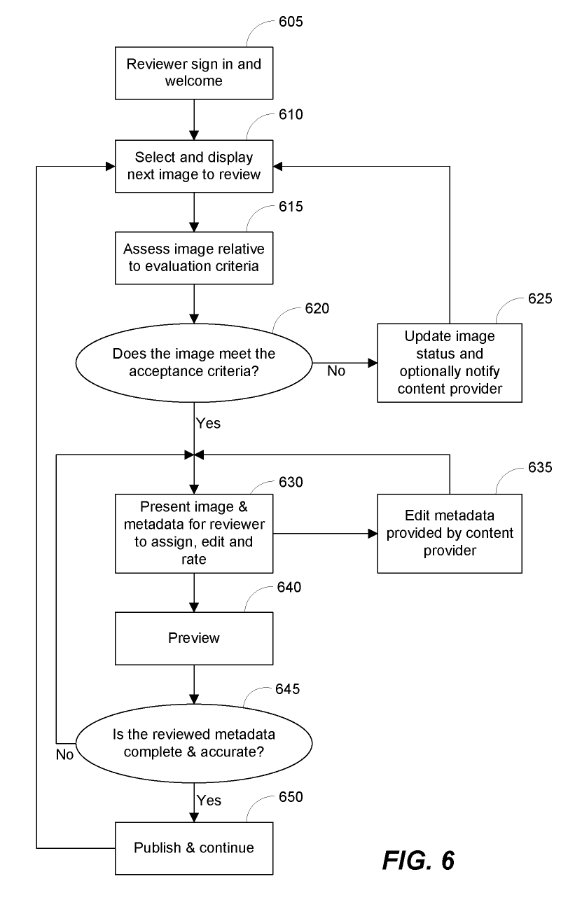

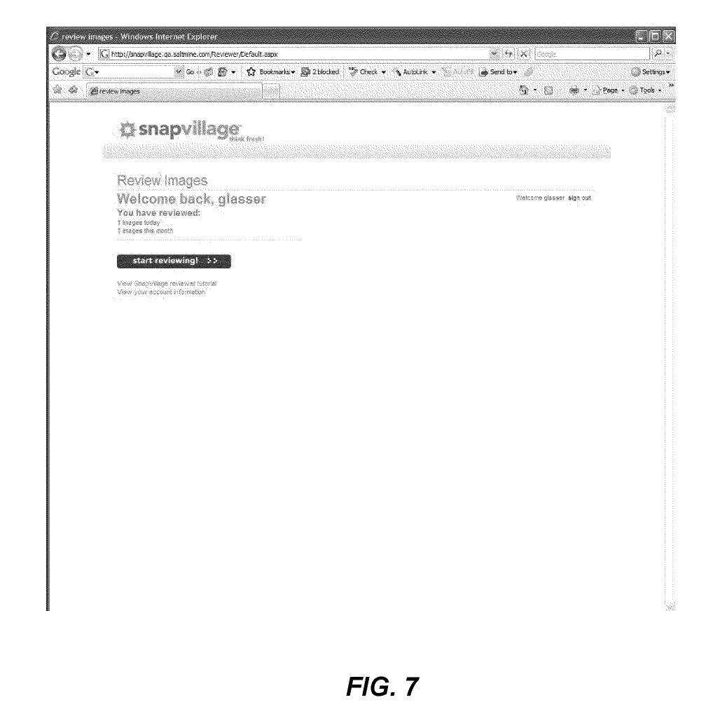

Reference is now made to FIG. 6, which is a simplified flowchart of a method for reviewing images, in accordance with an embodiment of the subject invention. The reviewer initiates the processing by signing in to the media review manager at Step 605. A standard username and password login is employed in one embodiment of the subject invention. But other types of logins are equally admissible. In one embodiment of the subject invention, once the user has successfully logged in he is presented with a welcome screen, depicted in FIG. 7.

Reference is now made to FIG. 7, which is an exemplary user interface that a reviewer is shown when he signs in, in accordance with an embodiment of the subject invention. As shown in FIG. 7, the welcome screen informs the reviewer of the number of images that he has reviewed today and in the last month. The reviewer can optionally sign out. In addition, there are options to view a user guide that provides tutorial information to the reviewer or to view account information. When the reviewer is ready to begin reviewing images he clicks a “start reviewing” control element, such as a button or link.

Referring back to FIG. 6, once the reviewer indicates that he is ready to proceed and to start reviewing images, processing moves to Step 610 where the media review manager selects the next media item to review and displays the image to the reviewer, as illustrated in FIG. 8.

The media review manager accommodates multiple simultaneous reviewers. Accordingly, it maintains a queue of media items to review, and employs an algorithm to assign images to each reviewer. The algorithm employed in one embodiment of the subject invention is first-in-first-out; i.e., the media item that has been awaiting review the longest is selected next. However, other selection algorithms can also be used. For example, in one embodiment, an image could be reviewed in parallel by multiple reviewers. In another embodiment, images could be assigned priorities and the selection algorithm would select the next item to be processed based on its priority.

At Step 615 the reviewer assesses the image relative to one or more evaluation criteria, as illustrated in FIG. 8, and makes a determination as to whether the image passes or fails for each individual evaluation criterion.

Reference is now made to FIG. 8, which is an example user interface that a reviewer uses to determine and indicate whether an image passes or fails specific acceptance criteria. Referring to the example pass/fail screen shown in FIG. 8, the reviewer evaluates the image and any additional metadata provided by the media review manager to determine whether the media item meets each of the acceptance criteria. The reviewer selects a “Pass” or “Fail” control 810 for each of the displayed criteria. In another embodiment, the reviewer may assign a “Pass” or “Fail” score or a rating value for each criterion. Optionally, the reviewer enters a comment that explains why the reviewer selected “Pass” or “Fail.”

TABLE I includes examples of specific acceptance criteria that are used for reviewing digital images.

TABLE I
Examples of criteria for reviewing digital images

| Criteria | Description |
|---|---|
| Image Quality | Does the image meet minimum photographic |
| | quality standards? |
| Objectionable | Does the image contain content that |
| Material | customers might find to be objectionable? |
| Trademarked or | Does the image content include visible |
| Copyrighted | trademarks or copyrighted materials that |
| Materials | would prevent it from being commercially |
| | licensed? |
| Includes model | Does the image require a model release, and |
| release | has the content provider provided a fully |
| | executed model release form? |

As an example, for the acceptance criterion “Image Quality,” the reviewer might assign a Fail and add a note that “the image is too blurry.” It will be appreciated by those skilled in the art that other criteria may be used in embodiments of the subject invention, including inter alia “Image Resolution”, “Image Tonality”, “Clarity of Subject”, and “Appropriate Pricing Level.”

It is also noted that some of the criteria listed in Table I are specific to licensing of digital images. However, if music, video or other media types are being reviewed, then criteria appropriate to the media being licensed is easily substituted.

Referring back to FIG. 6, after the reviewer has evaluated each acceptance criteria processing continues to Step 620, where the media review manager receives the reviewer's input and determines whether the image meets an overall acceptance criteria. In one embodiment of the subject invention, if the reviewer assigns a “Fail” to one or more of the specific acceptance criteria, the media review manager determines that the image did not meet the overall acceptance criteria, and processing moves to Step 625. In another embodiment, some of the specific acceptance criteria may be assigned a “Fail” value, but the overall acceptance criteria may satisfied.

At Step 625, the media review manager assigns a “Declined” state to the image. The declined state signifies that the image has been declined for publication. If the content provider has indicated that he wants to receive notification, then the media review manager notifies the content owner that the image has been declined. Notification methods include email, text message, voice notification, and the like. After completing processing at Step 625, processing returns to Step 610 and the media review manager displays the next image to be reviewed.

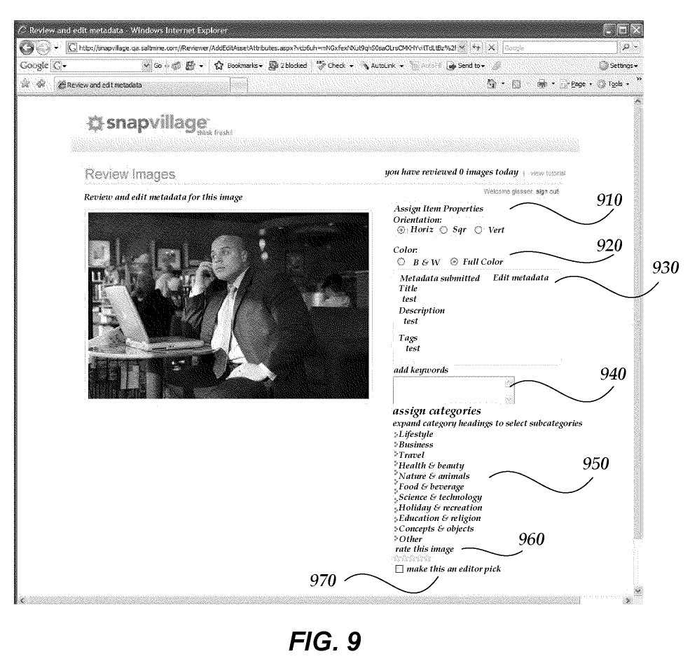

If at Step 620 the media review manager determines that the image meets the overall acceptance criteria, processing proceeds to Step 630, where the image, together with its associated metadata, are displayed, as illustrated in FIG. 9.

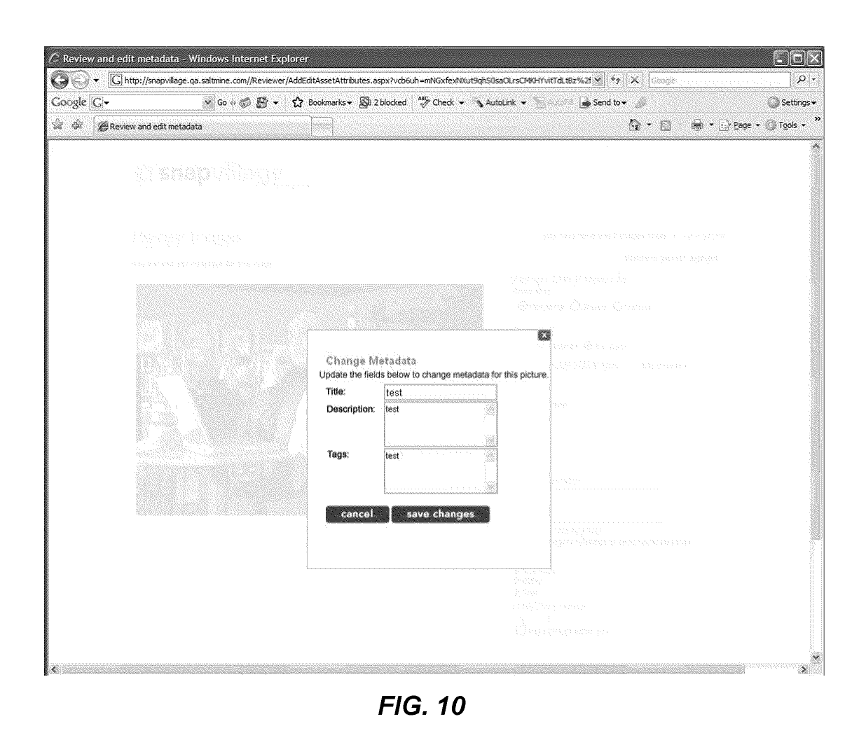

Reference is now made to FIG. 9, which is an example user interface that a reviewer uses to review metadata assigned by a submitting content provider, to add additional metadata, and to assign ratings. As shown in FIG. 9, the reviewer-facing user interface includes a number of radio buttons, text entry boxes, drop-down menus or other user interface controls that enable the reviewer to view, enter, edit, or otherwise associate information with the displayed image. This example user interface of the media review manager enables the reviewer to assign item properties (i.e. metadata) including orientation 910, and an indication of whether the image is in color 920. The reviewer may click an “Edit Metadata” control 930 to edit the metadata supplied by the content provider, as described in detail herein below with respect to FIG. 10. The reviewer may review, add, or edit search terms or other keywords 940. The reviewer may interact with a displayed tree structure or other groups to assign a category 950 and sub-category to an image. The reviewer may further assign a rating. In this example, reviewer ratings are in the form of a one to five-star rating 960, where one star is the lowest rating and five stars is the highest rating. In addition, a reviewer can assign an “editor pick” status 970 to an image. Selection as an editor pick denotes that the image is particularly distinctive or noteworthy. In general, metadata, including orientation, color, keywords and categories as well as ratings and “editor pick” status are used by customers for searching and browsing of images. For example, a customer might restrict a keyword search to include only vertical images. Any or all of the assigned review information may also impact a licensing price of the image.

Returning back to FIG. 6, if, at Step 630, the reviewer determines that the metadata provided by the content provider is defective, e.g., that it is not complete or not accurate, the reviewer may edit the metadata provided by the content provider at Step 635, as illustrated in FIG. 10.

Reference is now made to FIG. 10, which is an example user interface that a reviewer uses to edit metadata supplied by the content provider. In an embodiment of the subject invention, metadata provided by the content provider includes a descriptive title, a description, and a list of keywords or “tags” that are used for searching and browsing.

Returning to FIG. 6, while editing, or assigning metadata or ratings at Step 630, the reviewer can request to see a “preview” of the image together with its metadata. In this case, the media review manager displays the image along with its metadata as a preview of how this image will appear to a customer. Processing proceeds to Step 640. An example preview is illustrated in FIG. 11. At Step 645, the reviewer determines whether the metadata is complete and accurate. If the metadata is not complete or not accurate then the reviewer clicks a “make changes” control and, processing returns to Step 630. If, at Step 645, the reviewer determines that the metadata is complete and accurate, the reviewer selects a “publish and continue” control, and processing continues to Step 650.

At Step 650, the media review manager publishes the image and changes the status of the image to “published.” Also at Step 650, if the content provider has requested notification, the media review manager issues such notification. Once the metadata is made available to the customer-facing Web interface, the image will appear to customers that are browsing and searching for media. Processing then returns to Step 610, where the media review manager will select and display the next image to be reviewed.

Now reference is made to FIG. 11, which is an example user interface that a reviewer uses to preview an image along with its metadata. The reviewer may also either publish the image to the system or indicate that he wants to make further changes. This example user interface depicts an image being reviewed together with its associated metadata. The reviewer can click on a “make changes” control button, in which case processing returns to the edit and review step for this image. Alternatively, the reviewer may click on a “publish and continue” control button, in which case the image is published to the customer-facing Web interface. The reviewer is subsequently presented with the next image to be reviewed.

Once the reviewer decides to publish an image, the media review manager updates the status of the image. Generally, the status of an image reflects the last action taken on the image, either by the content provider or by the system. In one embodiment of the subject invention, a submitted media asset can have three states as shown in TABLE II.

TABLE II
Examples of image states

| Media Review | Description |
|---|---|
| Published | Image has successfully completed the review |
| | process and has been published. |
| Pending | Image has been submitted by content |
| | provider but has not yet completed the |
| | review process. |
| Declined | Image failed to meet the acceptance criteria |
| | and has been declined for publication. |

It will be appreciated by those skilled in the art that other states may be implemented in embodiments of the subject invention. For example, other state may include “waiting for model release,” “waiting for color enhancement”, “waiting for pricing,” or the like.

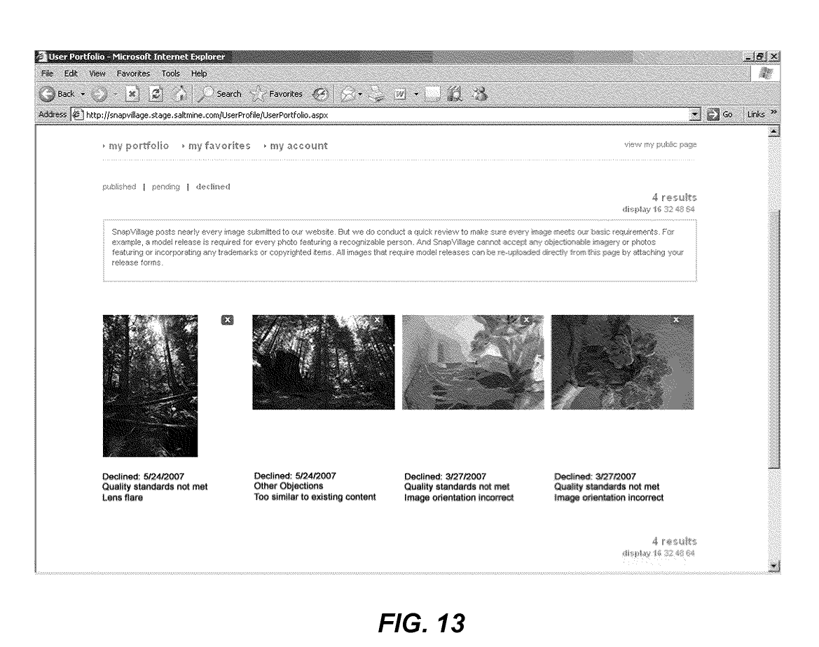

Reference is now made to FIG. 12, which is an example user interface that a content provider uses to review his portfolio of images that have been submitted to the system. Shown in FIG. 12 is a screen that is presented to the content provider when he accesses his account and selects a My Portfolio control element. The content provider is shown a list of his published images. In one embodiment of the subject invention, the content provider can scroll the window to see additional published images. Alternatively, the content provider can click on a “Pending” control element to see images that have been submitted but which have not been reviewed. Similarly, the content provider can click on a “Declined” control element to see images that were submitted and declined for publication. If the content provider selects the “Declined” control element, processing continues to display a screen shown in FIG. 13.

Reference is now made to FIG. 13, which is an example user interface that a content provider uses to review images that have been declined by the system. For each image that has been declined, a reduced size version of the image, often referred to as a “thumbnail”, is shown together with the date on which the image was declined. Any comments made by the reviewer are also shown in this embodiment.

The above specification, examples, and data provide a complete description of the manufacture and use of the composition of the invention. Thus it may be appreciated that the subject invention is advantageous for use with any digital media types including videos and video clips, movies, images, graphics, music, and spoken word recordings. More generally, the subject invention can be used in any case where it is advantageous to have independent reviewers add metadata to, perform reviews of, assess the quality of, rate or price media assets, digital documents, or other types of digital data. Further the subject invention may be employed to review physical assets such as automobiles, homes, and merchandise, which are represented by digital images or other media types. In this case, the media assets stand as proxies for the physical merchandise and the reviewer assesses characteristics of the physical assets depicted by the media assets, rather than assess the media assets themselves. It will also be appreciated that the reviewer information may be used to determine or adjust a score for one or more assets. This is sometimes referred to as a “snappyness” score, as described in patent application titled “PROVIDING A RATING FOR DIGITAL MEDIA BASED ON REVIEWS AND CUSTOMER BEHAVIOR,” filed on Jun. 22, 2007, listing inventors Adam Brotman, Glen O'Connor, Nandini Ranjitkumar, and Todd Guill, with attorney docket number 08228/0207316-USO, the entire contents of which are incorporated herein by reference. Similarly, the reviewer information may be used to determine or adjust pricing of assets. Since many embodiments of the invention can be made without departing from the spirit and scope of the invention, the invention resides in the claims hereinafter appended.

What is claimed as new and desired to be protected by Letters Patent is:

1. A method for reviewing media assets in an online media licensing system, comprising:
receiving at least one media asset from a content provider;
receiving from the content provider a suggested price for the at least one media asset;
providing an interface to a plurality of reviewers, such that each of the plurality of reviewers can simultaneously review the at least one media asset, including providing a description of the at least one media asset;
receiving from each of the plurality of reviewers a review of the at least one media asset;
using the plurality of reviews and suggested price to dynamically determine a price for the at least one media asset; and
enabling at least one reviewer in the plurality of reviewers to publish the at least one media asset to the online media licensing system, including the descriptions and determined price.

2. The method of claim 1, further comprising:
enabling each reviewer to determine if the at least one media asset meets a set of acceptance criteria; and
determining if the media asset will be declined as a consequence.

3. The method of claim 1, further comprising: enabling each reviewer to assign a rating to the media asset.

4. The method of claim 1, wherein each review includes at least one intrinsic and extrinsic value factor about the at least one media asset, and wherein the at least one intrinsic and extrinsic value factor are used, at least in part, to dynamically determine the price of the at least one media asset.

5. The method of claim 1, further comprising: notifying a content provider when a status of at least one media asset changes.

6. The method of claim 1, wherein each review further comprises a categorization of at least one media asset, and wherein the categorizations are configured to be aggregated.

7. A network device configured to enable reviewing of media assets in an online media licensing system, comprising:
a transceiver to send and receive data over a network; and
a processor that is operative to perform actions, comprising:
receiving a media asset from a content provider;
receiving from the content provider metadata about the media asset, including at least a description of the media asset;
providing to a plurality of reviewers parallel access to the media asset;
receiving from each parallel reviewer value factors about the media asset, and at least one categorization of use for the media asset;
using the plurality of value factors and categorizations of use to dynamically determine a price of the media asset; and
enabling the reviewers to publish the media asset and at least some of the value factors to enable a searcher to locate the media asset.

8. The network device of claim 7, wherein the at least one categorization of use is selectable from within a tree structure of categories.

9. The network device of claim 7, wherein the categorizations of use are useable for searching for the media asset.

10. The network device of claim 7, wherein dynamically determining the price further comprises determining the price based on at least one of an intrinsic characteristic of the media asset and a change in at least one extrinsic characteristic of the media asset.

11. The network device of claim 7, further comprising: providing to each of the plurality of reviewers, a plurality of media assets to be reviewed, wherein each media asset in the plurality of media assets is provided based at least on an assigned priority for review.

12. A processor readable storage medium that includes data and instructions, wherein the execution of the instructions on a computing device provides for reviewing media assets in an online media licensing system by enabling actions, comprising:
receiving a media asset from a content provider;
receiving from the content provider metadata about the media asset, including at least a description and suggested price of the media asset;
providing to a plurality of reviewers parallel access to the media asset;
receiving from each parallel reviewer value factors about the media asset, and at least one categorization of use for the media asset;
using the plurality of value factors and categorizations of use to dynamically determine a price of the media asset; and
selectively publishing the media asset and at least some of the value factors to enable a purchase of the media asset.

13. The processor readable storage medium of claim 12, wherein the publishing of the media asset further enables searching for the media asset within the online media licensing system based on the categorizations of use or value factors; and wherein enabling the purchase further enables licensing the media asset for use.

14. The processor readable storage medium of claim 12 wherein at least one value factor includes an indication of if the media asset passes or fails an individual evaluation criterion.

15. The processor readable storage medium of claim 12, wherein the content provider is provided an interface to view a status of the media asset.

16. The processor readable storage medium of claim 12, wherein at least one value factor received modifies at least some metadata received from the content provider.

17. The processor readable storage medium of claim 12, wherein selectively publishing the media asset further comprises: if the media asset is determined during the reviews to fail at least one acceptance criteria, selecting to decline to publish the media asset.

18. A system for reviewing media assets in an online media licensing system, comprising:
A plurality of content access components, each component being accessible through a different client device, and each content access component being configured to perform actions, including:
providing concurrent access to media assets provided by a content provider;
concurrent with other content access components, enable a reviewer to view, edit, and provide a review of the media assets, wherein the review includes at least one intrinsic and one extrinsic value factor for each of the media assets reviewed; and
a media review manager residing within a server that is configured to perform actions, including:
receiving reviews for the media assets reviewed from each of the plurality of concurrent content access components;
employing the reviews to determine a recommended price for the media assets; and
selectively publishing the media assets and at least some of the value factors to enable searching for the media assets.

19. The system of claim 18, wherein selectively publishing the media assets further comprises: declining to publish the media assets to the online media licensing system if at least one reviewer determines that the media assets fail to satisfy at least one pre-determined publishing criterion.

20. The system of claim 18, wherein the recommended price is dynamically modified based on a change in at least one review of the media assets.

21. The system of claim 18, wherein the content provider is notified of a change in the recommended price.
